(19) United States
(12) Patent Application Publication
(10) Pub. No.: US 2017/0329781 A1
(43) Pub. Date: Nov. 16, 2017

(54) System for Choosing Data

(71) Applicant: James H. M. Stuart-Smith, Cheltenham (GB)

(72) Inventor: James H. M. Stuart-Smith, Cheltenham (GB)

(21) Appl. No.: 15/155,112

(22) Filed: May 16, 2016

(51) Int. Cl. G06F 17/30

(52) U.S. Cl. CPC G06F 17/3053; G06F 17/30528

(57) ABSTRACT

A system for choosing data to be displayed on a first device. The system includes a first database comprising an autocomplete dictionary which is the default autocomplete database for the device, used by several applications on the device. The system also includes a second database listing data to be displayed on the device and selecting means for selecting from the said second database data to be displayed at any given time. The first database includes a vocabulary of words commonly used by the user of the device and ranked or weighted by their frequency of use and that the said selecting means is configured to access the said words in the first database together with their rank or weighting and select from the second database data to be displayed based partly or wholly on the said words and their rank or weighting.

### BACKGROUND

Currently, third-party content items such as advertisements displayed alongside the main user-chosen content on a device screen have been based on data from websites visited by the user. There is a desire to improve the ability to predict content likely to be of interest to the user, in order to target advertisements and other material more appropriately to the individual in question.

### SUMMARY

At least one aspect is directed to a system for choosing data to be displayed on a first device. The system includes a first database comprising a dictionary, a second database which lists data to be displayed on the device and selecting means for selecting data from the said second database to be displayed at any given time. The first database includes a vocabulary of words commonly used by the user of the device and ranked or weighted by their frequency of use across more than one application on the device. The selecting means is configured to access the said words in the first database together with their rank or weighting and select from the second database data to be displayed based partly or wholly on the said words and their rank or weighting.

In some implementations the database is used as a dictionary by several applications on the device. In some implementations the first database is the default dictionary for the device.

In some implementations the selecting means is configured to select data for display that includes one or more of the said words. In some implementations the selecting means is configurable by the user to include or exclude specific words chosen by the user.

In some implementations the system includes a correlating database which correlates websites visited by multiple devices with the rank or weighting of words used on those devices and said selecting means is configured to select data to be displayed by comparing the rank or weighting of words on the said first device with the rank or weighting of words in the correlating database.

In some implementations the correlating database is the said second database.

In some implementations the first database is stored on the device.

In some implementations the selecting means is configured to select data by selecting a first group of data based on the rank or weighting of the said words and then making a further selection within that subgroup based on a second method.

In some implementations the second method is a sequential selection of data within the said subgroup.

In some implementations the second method is a random or quasi random selection of data within the said subgroup.

In some implementations the selecting means stores some of the said words together with their weight or ranking in a further database remote from the said first database.

In some implementations the selecting means stores a list of selected data to be displayed which list is updated from time to time.

These and other implementations and aspects are described in detail below. The summary and the detailed description that follows include illustrative examples of various aspects and implementations and provide an overview and framework for understanding the claimed aspects and implementations.

### BRIEF DESCRIPTION OF THE DRAWINGS

Illustrative embodiments of the present invention are described in detail below with reference to the attached drawings which are incorporated by reference herein and wherein:

FIG. 1 illustrates a flow diagram of a system incorporating a first embodiment of the current invention.

FIG. 2 illustrates by means of a block diagram the architecture of the system of FIG. 1

FIG. 3 illustrates a flow diagram of a system incorporating a second embodiment of the current invention and

FIG. 4 illustrates by means of a block diagram the architecture of the system of FIG. 3

### DETAILED DESCRIPTION

There follow below more detailed descriptions of concepts and implementations of methods, apparatuses and systems for choosing data to be displayed on the screen of a computer, tablet, mobile device or other device having a screen. These descriptions of embodiments of the invention are intended to be illustrative rather than restrictive. Alternative embodiments that do not depart from the scope of the present invention will become apparent to those skilled in the art. Not all steps listed in the various figures need to be carried out in the order described.

The invention may be realised through, among other things, computer hardware, computer software, remotely transmitted instructions stored in a variety of manners. Different embodiments may use a combination of methods of realisation.

In some modes the screen based device divides the real estate of the screen, often dedicating some of the screen availability to third-party content items, including but not limited to advertising of commercial or non-commercial services, products and information. In different implementations the screen based device may be an items such as a computer, television, tablet, mobile phone or games console. In different implementations the real estate available for advertising may be a bar down one side of the screen, pop-ups that appear on the screen and full-screen displays that appear at the end of a game or session. In different implementations, this may be controlled at any one time by the operating system, an application, including email or social media, or a browser.

The screen based device also includes a means for inputting data. In different implementations this may be a keyboard, either displayed on the touch screen or separate to the screen. It may also be a voice recognition system. It may also be an alphanumeric input in which letters are selected individually using a cursor. Other implementations may be via a telephone numeric keypad.

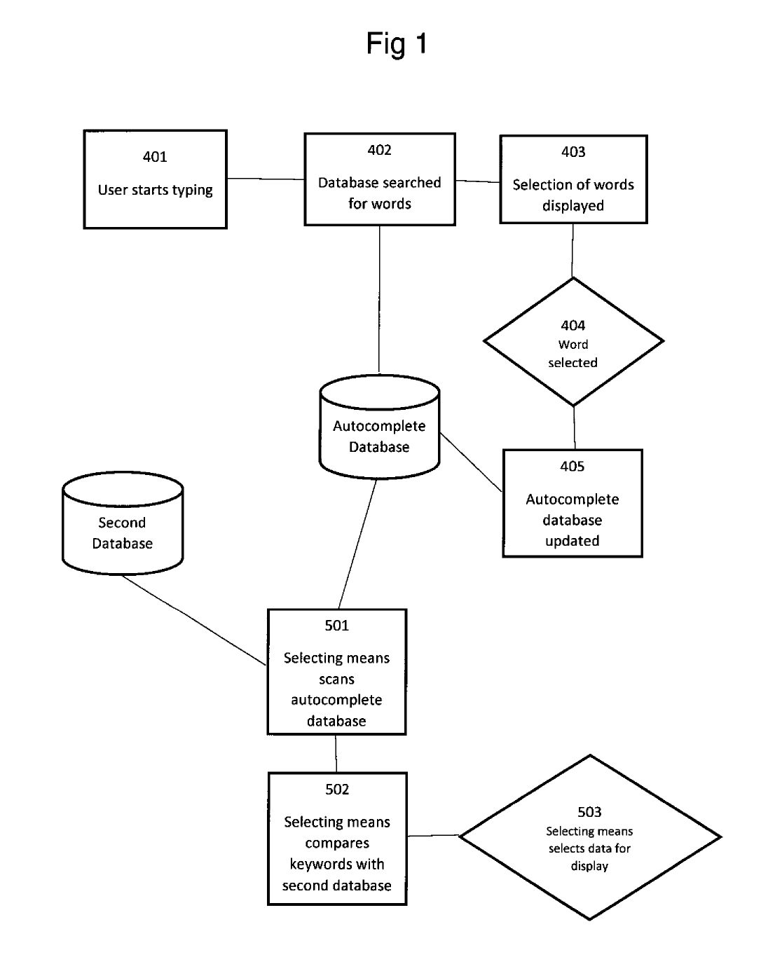

FIG. 1 shows a flow diagram of a system incorporating a first implementation of the current invention. In this implementation the device has an autocomplete database to reduce the effort of typing by completing or autocorrecting words as they are typed installed on the device, which acts as the default autocomplete database and is used by several applications across the device. In implementations the autocomplete database will be used by applications including but not limited to word processing applications, social media applications, calendar applications, email applications, games applications and all combinations thereof.

The autocomplete goes through a first loop as the user types. Each time the user starts to type a word 401 the database is searched for words starting with the string typed or with common mis-typings that may result in the string typed 402. A selection of these words is displayed on the screen 403. The user can either select one of the words displayed or can continue to type the complete word that they meant to use 404. In either case, the database is updated 405 to reflect the choice of word, giving it a weighting based on its frequency of use by the user. This weighting is subsequently used to select words to be displayed when the same opening string is typed. For example, if the user types the word “band” very often, the system will display this word among the selections when B and A are typed, in preference to other words such as bad, banter or bandage, assuming these words are typed less commonly by the user. However if over time the user starts to type “banter” much more frequently, the respective weightings will adjust and “banter” will be displayed as a choice when B and A are typed, displacing another word from the list. Contextual weightings may also be applied in the words chosen to be displayed but these do not affect the frequency weighting of the words. Depending on the configuration of the autocomplete system, common words like “the” may or may not be weighted for frequency of use.

A second database, held off the device in this implementation and accessed via a network, lists data to be displayed. The second database may also store the data to be displayed or it may provide links to the data which is stored in various places elsewhere. The data may be advertisements. Associated with each listed item of data are various keywords. These may be directly related to the data. For example a watch advertisement may have the word “watch” associated with it, along with other words. The keywords may also be less directly related to the data. For example, the word “outdoor” may be linked with an advertisement for running shoes.

The system also includes a selecting means, held in this embodiment off the device and accessed via a network. The selecting means from time to time scans the autocomplete database 501 and notes words which are recorded as having a high frequency of use and which are not common words like “the”. It then compares these words with the keywords in the second database 502. Where there is a match between the noted words and the keywords the selecting means chooses the associated data 503 for display on the screen of the device. Commonly there will be several matches, in which case the selecting means may use other selection techniques to reduce the number of data items to be displayed and commonly also display the various data items either sequentially or at random.

To avoid the need for constant access to the autocomplete database the selecting means can either hold a copy of the database locally and update it from time to time or hold a selection of words with or without their weighting, which is again updated from time to time. Conveniently the selecting means may also store on the device a list of data items to be displayed which is updated from time to time.

By virtue of the fact that the autocomplete feature is used over more than one application the data provided gives a more complete picture of the user's interests than is achieved by monitoring only web traffic, for example. Consequently the user is more likely to be provided with data that is of interest to them. To avoid undesired data relating to specific interests from being displayed a user-controlled word filter may be included.

In other implementations the autocomplete database may be installed remotely from the device.

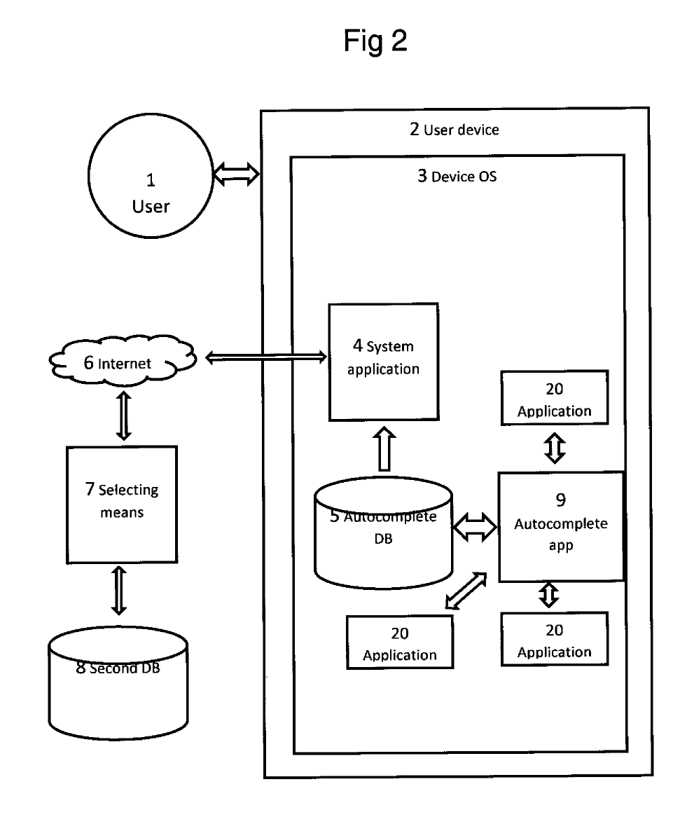

FIG. 2 shows the architecture of a system incorporating the implementation shown in FIG. 1. A user 1 interacts with the user device 2. The device 2 includes an operating system 3. Running within the operating system is a system application 4 forming part of the current invention. The system application retrieves words together with ranking or weighting data from an autocomplete database 5 and transmits this data via the internet 6 to a selecting means 7 which compares the word data with data held on a second database 8. The selecting means then returns data to the user device 2 via the internet where the system application 4 allows it to be displayed. An autocomplete application 9 exchanges data with several applications 20 on the device and updates the autocomplete database 5, based on the entries typed by the user within any of the applications 20. It will be appreciated that the invention applies equally to a similarly operating autocorrect or other dictionary database and application, as already stated.

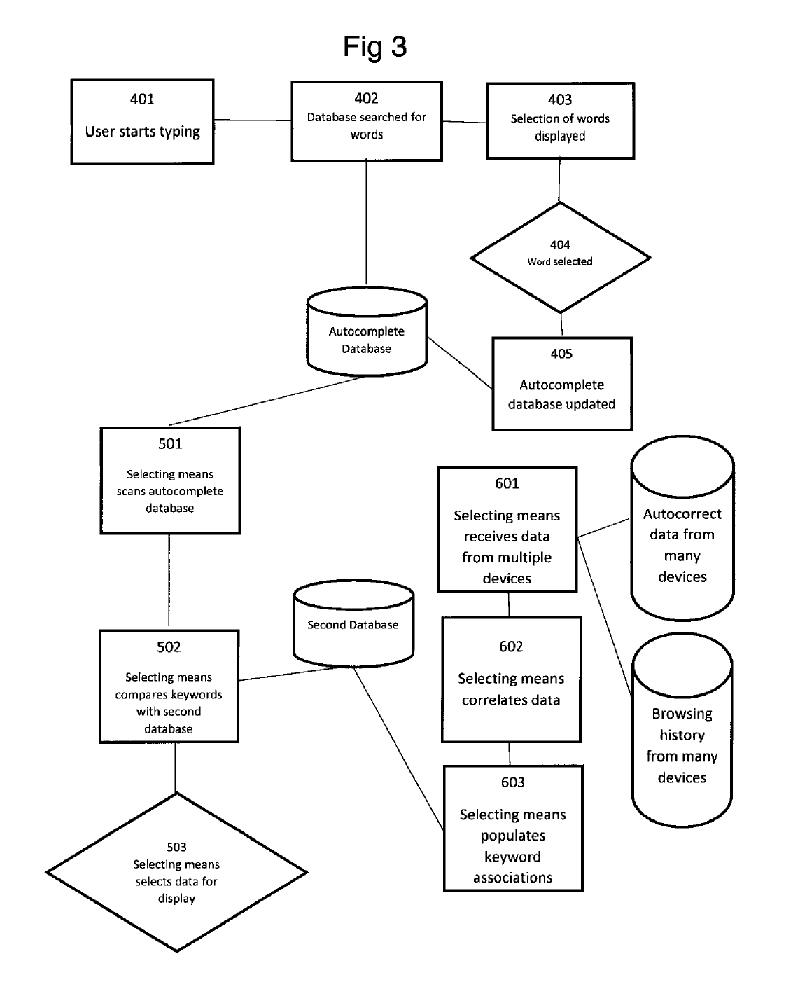

FIG. 3 shows a flow diagram of another implementation of the current invention. In this implementation, the autocorrect process is the same as the implementation of FIGS. 1 and 2. The selecting means downloads either a copy of the autocorrect database or a selection of words with or without their weightings, as in the embodiment of FIGS. 1 and 2. The selecting also receives from the device details of websites visited by the user. In this implementation these details are anonymised. The selecting means collects the same data sets from a large number of devices 601, all anonymised. It then correlates in a correlating database the autocorrect words with websites visited over the data sets to provide a table of websites associated with keywords 602. The table may or may not include a weighting based on the degree of correlation found.

The table is then used to populate the keyword associations in a database corresponding to the second database in the first embodiment 603. This database may be a separate database to the correlating database or the two may be the same database. The keyword population may be a direct mapping, whereby keywords are linked directly to the sites with which they have a high correlation with visits. For example, if there is a high correlation between the word “Hearst” and visits to the Hearst castle website, then the keyword “Hearst” could be linked to the Hearst castle website. Alternatively there could be an indirect mapping, where the correlation between the word “Hearst” and the Hearst castle website results in a link to a site providing comfortable walking shoes.

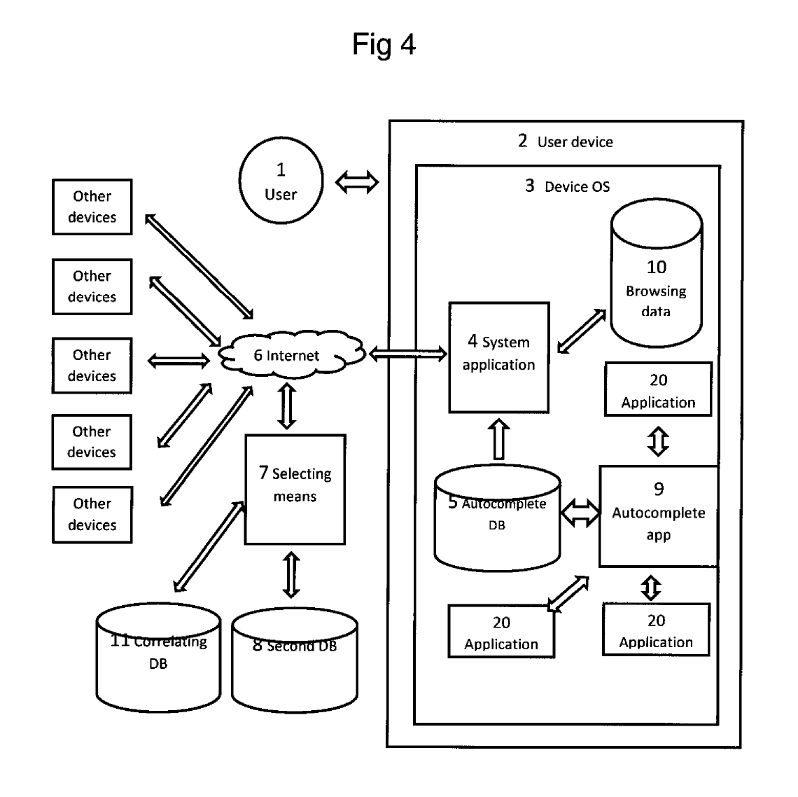

FIG. 4 shows the architecture of the system of FIG. 3. The architecture is similar to that of FIG. 2 but includes also on the device a store of browsing data 10 which is transmitted to the selecting means 7 via the internet. The selecting means is also connected to and able to retrieve word and browsing data from multiple other devices used by other users. The data from these many devices is correlated and stored in a correlating database 11. The selecting means uses data from the correlating database 11, which may be part of the second database 8, to populate the keyword associations in the second database 8.

Other implementations of the invention may incorporate other means of refining further the selection of data using known means. For example the use of geographical data can be used to refine the selection further.

While this specification contains many specific implementation details, these should not be construed as limitations on the scope of any inventions or of what may be claimed, but rather as descriptions of features specific to particular implementations of the systems and methods described herein. The foregoing description and drawings are illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations. The processes depicted in the accompanying figures do not necessarily require the particular order shown to achieve desirable results.

The separation of various system components in the implementations described above should not be understood as requiring such separation in all implementations. Similarly, some single components and processes described or shown may be split into sub-components and sub-processes. Any implementation may be combined with any other implementation, inclusively or exclusively, in any manner consistent with the aspects and implementations disclosed herein.

The terminology used herein should not be regarded as limiting. The use of “including” “comprising” “having” “containing” and variations thereof herein, is meant to encompass the items listed thereafter, equivalents thereof, and additional items. References to the singular should be taken to include references to the plural and references to the plural should be taken to include references to the singular. References to “or” may be construed as inclusive so that any terms described using “or” may indicate any of a single, more than one, and all of the described terms

The systems and methods described herein may be embodied in other specific forms without departing from the characteristics thereof. Although the examples provided herein relate to a third-party content choosing system, the systems and methods described herein can be applied to any system for choosing content to be displayed. Scope of the systems and methods described herein is indicated by the appended claims, rather than the foregoing description, and changes that come within the meaning and range of equivalency of the claims are embraced therein.

Where technical features in the drawings, detailed description or any claim are followed by reference signs, the reference signs have been included solely to allow understanding of the drawings, detailed description, and claims. Accordingly neither the reference signs nor their absence have any limiting effect on the scope of any claim elements

The invention claimed is:

1. A system for choosing data to be displayed on a first device the system including a first database comprising a dictionary, a second database listing data to be displayed on the device and selecting means for selecting from the said second database data to be displayed at any given time, wherein the first database includes a vocabulary of words commonly used by the user of the device and ranked or weighted by their frequency of use across more than one application on the device and that the said selecting means is configured to access the said words in the first database together with their rank or weighting and select from the second database data to be displayed based partly or wholly on the said words and their rank or weighting.

2. A system as claimed in claim 1, wherein the first database is the default dictionary for the device.

3. A system as claimed in claim 1, wherein the first database is used as a dictionary by several applications on the device.

4. A system as claimed in claim 1, wherein the selecting means is configured to select data for display that includes one or more of the said words.

5. A system as claimed in claim 1, wherein the selecting means is configurable by the user to include or exclude specific words chosen by the user.

6. A system as claimed in claim 1 wherein the selecting means stores some of the said words together with their weight or ranking in a further database remote from the said first database.

7. A system as claimed in claim 1 wherein the selecting means stores a list of selected data to be displayed which list is updated from time to time.

8. A system as claimed in claim 1 wherein the system includes a correlating database which correlates websites visited by multiple devices with the rank or weighting of words used on those devices and said selecting means is configured to select data to be displayed by comparing the rank or weighting of words on the said first device with the rank or weighting of words in the correlating database.

9. A system as claimed in claim 8 wherein the correlating database is the said second database.

10. A system as claimed in claim 1 wherein the first database is stored on the device.

11. A system as claimed in claim 1 wherein the selecting means is configured to select data by selecting a first group of data based on the rank or weighting of the said words and then making a further selection within that subgroup based on a second method.

12. A system as claimed in claim 11 wherein the said second method is a sequential selection of data within the said subgroup.

13. A system as claimed in claim 11 wherein the second method is a random or quasi random selection of data within the said subgroup.
